(19) United States
(12) Patent Application Publication
(10) Pub. No.: US 2013/0001984 A1
(43) Pub. Date: Jan. 3, 2013

(54) SYSTEM FOR CONTROLLING TEMPERATURE IN A MACHINE CAB

(75) Inventor: Stuart R. SPENCER, Holly Springs, NC (US)

(73) Assignee: Caterpillar Inc.

(21) Appl. No.: 13/170,322

(22) Filed: Jun. 28, 2011

(51) Int. Cl. B62D 33/06; F28D 15/00

(52) U.S. Cl. 296/190.09; 165/104.34

(57) ABSTRACT

A system for controlling temperature inside a machine cab defining an interior and an exterior includes a blower fan configured to be coupled to the exterior of the cab. The system also includes an evaporator configured to be coupled to the exterior of the cab at a location separated from the blower fan. The system further includes a duct coupled to the blower fan and the evaporator and extending between the blower fan and the evaporator.

### TECHNICAL FIELD

The present disclosure relates to a system for controlling temperature, and more particularly, to a system for controlling temperature in a machine cab.

### BACKGROUND

Heating, ventilation, and air conditioning systems (HVAC systems) are used to control the temperature of interior spaces. For example, machines having cabs that provide operators with protection from the elements may include HVAC systems to provide operator comfort. However, some machines may have cabs mounted for repositioning relative to a machine chassis on which the cab is mounted. Such mounting may contribute to drawbacks associated with traditional HVAC systems, such as, for example, creation of leaks in the HVAC system resulting from repeated movement of the cab relative to the chassis. In addition, some machines may be relatively small, resulting in relatively small cabs, which provide limited space for HVAC system components.

An air handling system for the cab of a skid steer loader is disclosed in U.S. Pat. No. 6,223,807 B1 to Asche et al. (“the '807 patent”). In particular, the '807 patent discloses an airflow housing mounted on the exterior of the cab. The housing includes a heater core and an air conditioning evaporator mounted in a plenum chamber in which two fans are mounted. Ducts lead from the plenum to the interior of the cab.

Although the system disclosed in the '807 patent may serve to control temperature in the cab, the system may suffer from a number of potential drawbacks. For example, by virtue of the fans, heater core, and air conditioning evaporator being located adjacent one another in a common plenum, the system may result in less advantageous placement of other components of the skid steer loader. Thus, it may be desirable to mitigate or overcome the potential drawbacks.

### SUMMARY

In one aspect, the present disclosure includes a system for controlling temperature inside a machine cab defining an interior and an exterior. The system includes a blower fan configured to be coupled to the exterior of the cab and an evaporator configured to be coupled to the exterior of the cab at a location separated from the blower fan. The system further includes a duct configured to be coupled to the blower fan and the evaporator such that the duct extends between the blower fan and the evaporator.

According to a further aspect, the present disclosure includes a machine including a chassis, ground engaging members coupled to the chassis, and a cab defining an interior and an exterior, the cab being coupled to the chassis. The machine further includes a system for controlling temperature in the interior of the cab. The system includes a blower fan coupled to the exterior of the cab and an evaporator coupled to the exterior of the cab at a location separated from the blower fan. The system further includes a duct coupled the blower fan and the evaporator and extending between the blower fan and the evaporator.

According to another aspect, the disclosure includes a system for controlling temperature inside a machine cab defining an interior. The system includes a blower fan configured to be coupled to a cab and an evaporator configured to be coupled to the cab at a location separated from the blower fan. The system further includes a duct coupled to the blower fan and the evaporator and extending between the blower fan and the evaporator, wherein the duct has an increasing cross-sectional area as it extends from the blower fan to the evaporator.

### BRIEF DESCRIPTION OF THE DRAWINGS

FIG. 1 is a pictorial perspective view of an exemplary embodiment of a machine.

FIG. 2 is a pictorial perspective, rear view of an exemplary embodiment of a machine cab.

FIG. 3 is a pictorial perspective view of a portion of an exemplary embodiment of a system for controlling temperature in a machine cab.

FIG. 4 is a pictorial perspective view of an exemplary embodiment of a system for controlling temperature in a machine cab.

FIG. 5 is a schematic diagram of an exemplary embodiment of a system for controlling temperature in a machine cab.

### DETAILED DESCRIPTION

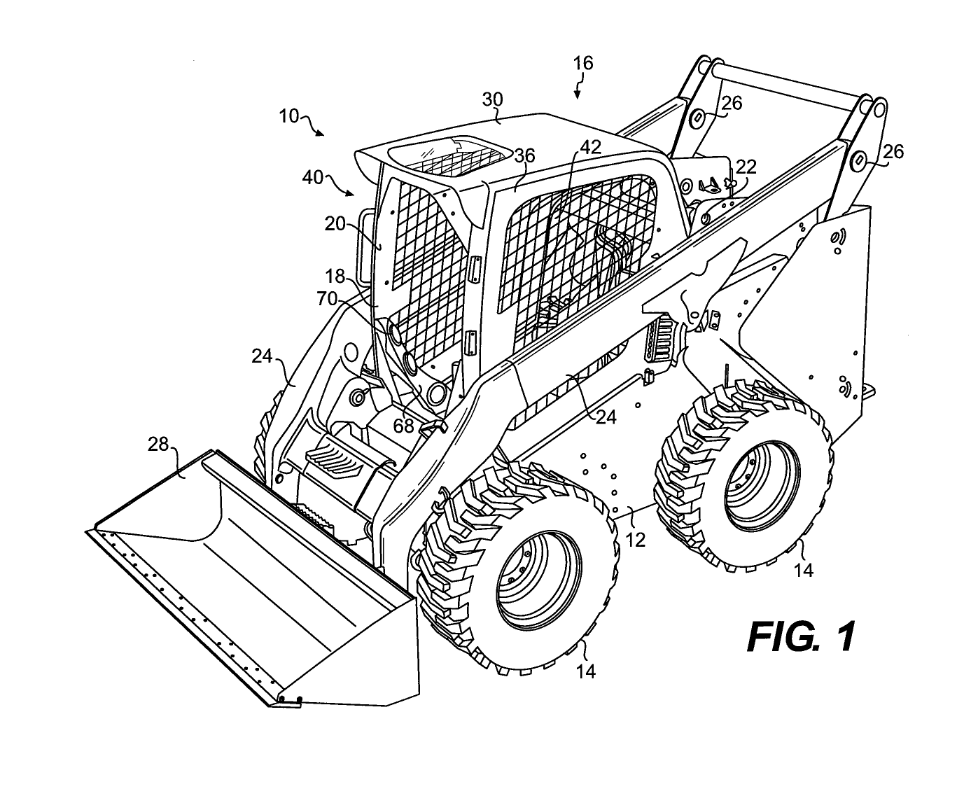

FIG. 1 shows an exemplary embodiment of a machine 10 for performing work. In particular, the exemplary machine 10 shown in FIG. 1 is a skid steer loader for performing operations such as digging and/or loading material. Although the exemplary systems and methods disclosed herein are described in relation to a skid steer loader, the disclosed systems and methods have applications in other machines, such as an automobile, truck, agricultural vehicle, wheel loader, dozer, loader, track-type tractor, grader, off-highway truck, or any other machines known to those skilled in the art. For example, the systems and methods may be used with multi-terrain loaders and compact track loaders, which are similar to skid steer loaders, except they have ground engaging tracks instead of wheels.

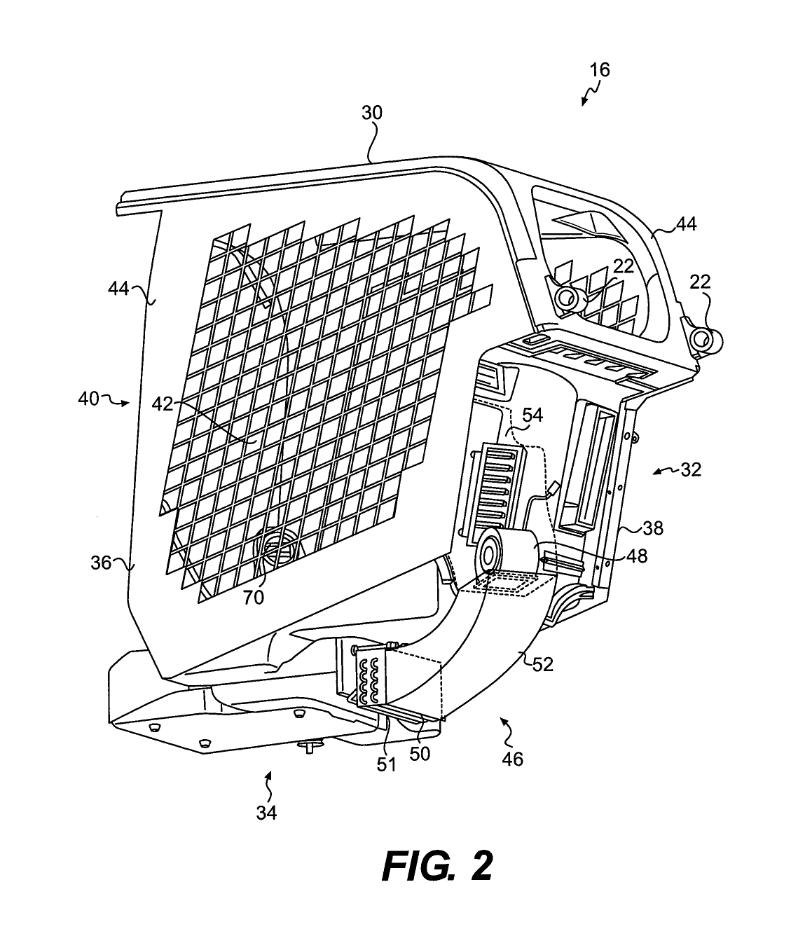

As shown in FIG. 1, exemplary machine 10 includes a chassis 12 flanked by ground-engaging members 14 (e.g., ground-engaging wheels or tracks) for moving machine 10. Machine 10 includes a machine cab 16 mounted to chassis 12. Exemplary cab 16 shown in FIG. 1 is enclosed to protect the operator from the environment and includes a door 18 at an opening 20 of cab 16 for permitting an operator access to the interior of cab 16. According to some embodiments, such as shown in FIG. 1, cab 16 may be mounted to chassis 12 via hinges 22 (FIG. 2), such that cab 16 may be pivoted about hinges 22 with respect to chassis 12, for example, to gain access to components of machine 10 located under or immediately adjacent cab 16.

As shown in FIG. 1, exemplary machine 10 includes a pair of arms 24 pivotally coupled to a rear end of chassis 12 at hinges 26. At an end of arms 24 opposite hinges 26, arms 24 are configured to receive a work implement 28. For example, the exemplary work implement 28 shown in FIG. 1 is a bucket pivotally coupled to arms 24 and configured for digging and/or loading material. Although exemplary machine 10 includes a bucket, other work implements may be coupled to arms 24 when other types of work are desired to be performed.

As shown in FIG. 2, exemplary cab 16 includes a roof 30, a rear end 32, an underside 34, opposing sides 36 and 38, and a front end 40, all defining an interior 42 of cab 16. According to some embodiments, roof 30, rear end 32, opposing side walls 36 and 38, and/or front end 40 may include transparent panels (e.g., tempered glass and/or a transparent polymer) for substantially enclosing interior 42 of cab 16. As shown, front end 40 includes door 18 for permitting access to interior 42 of cab 16. Exemplary cab 16 also includes frame members 44 configured to provide the operator with protection.

As shown in FIG. 2, exemplary machine 10 also includes a system 46 for controlling the temperature of interior 42 of cab 16. In the exemplary embodiment shown in FIG. 2, system 46 includes a blower fan 48 coupled to rear end 32 of cab 16, and an evaporator 50 (e.g., including an evaporator coil) coupled to underside 34 of cab 16. A duct 52 coupled to blower fan 48 extends between blower fan 48 and evaporator 50. According to some embodiments, the cross-sectional area of duct 52 expands (e.g., gradually) as it extends from blower fan 48 to evaporator 50. In this exemplary manner, blower fan 48 and evaporator 50 are separated from one another by the length of duct 52. According to some embodiments, a heater core 51 may be mounted adjacent to evaporator 50 and may facilitate heating interior 42 of cab 16. Thus, when exemplary system 46 includes a heater core 51, the air for heating cab 16 takes the same path as air used to cool cab 16. According to some embodiments, heater core 51 may be integrally-formed with evaporator 50.

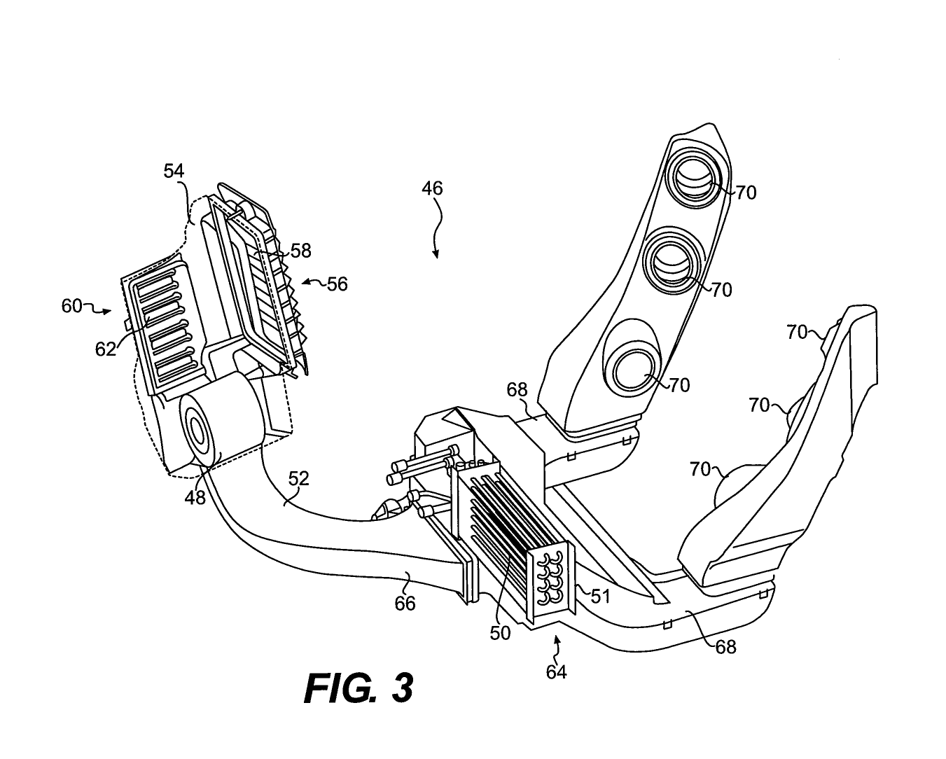

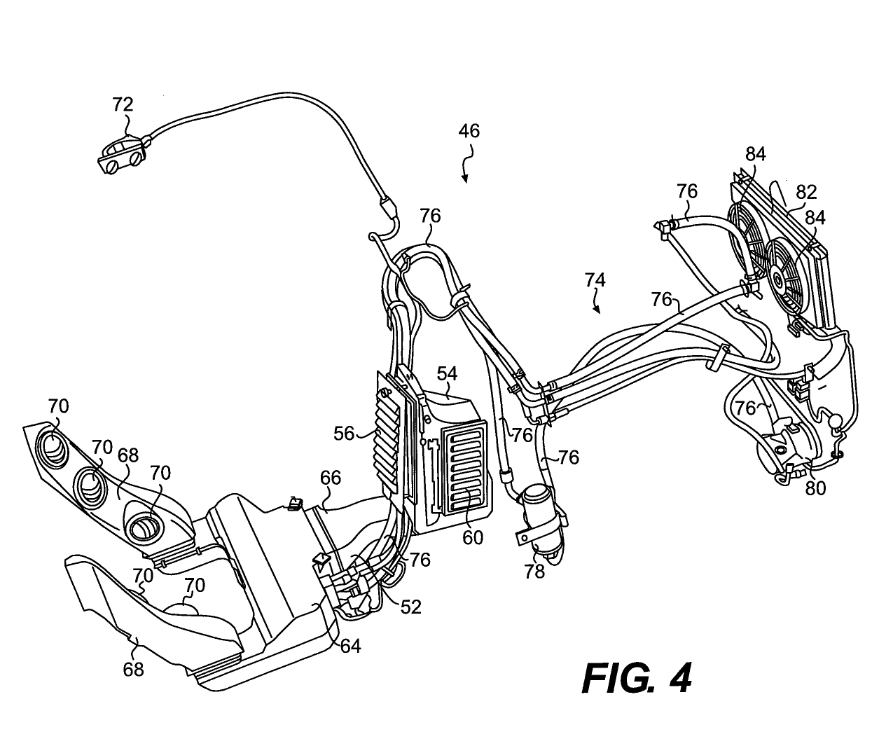

As shown in FIGS. 3 and 4, exemplary system 46 includes a plenum 54 associated with blower fan 48. Plenum 54 includes a first inlet 56 configured to receive air from interior 42 of cab 16. In the exemplary system 46 shown, first inlet 56 is adjacent rear end 32 of cab 16. A first filter 58 is mounted in plenum 54 adjacent first inlet 56 and is configured to filter particles from air entering first inlet 56 via interior 42 of cab 16. Exemplary plenum 54 also includes a second inlet 60 configured to receive air from exterior to cab 16. Second inlet 60 is adjacent one of opposing side walls 36 and 38 of cab 16, and a second filter 62 is mounted in plenum 54 adjacent second inlet 60 and is configured to filter particles from air entering plenum 54 from exterior to cab 16.

As shown in FIGS. 3 and 4, system 46 includes a chamber 64 in which evaporator 50 is housed. An end 66 of duct 52 remote from blower fan 48 is coupled to chamber 64, and a pair of ventilation passages 68 extend from chamber 64 into interior 42 of cab 16. Flow communication is provided sequentially between blower fan 48, duct 52, chamber 64, evaporator 50, and ventilation passages 68. Ventilation passages 68 include a number of vents 70 for providing flow communication between ventilation passages 68 and interior 42 of cab 16.

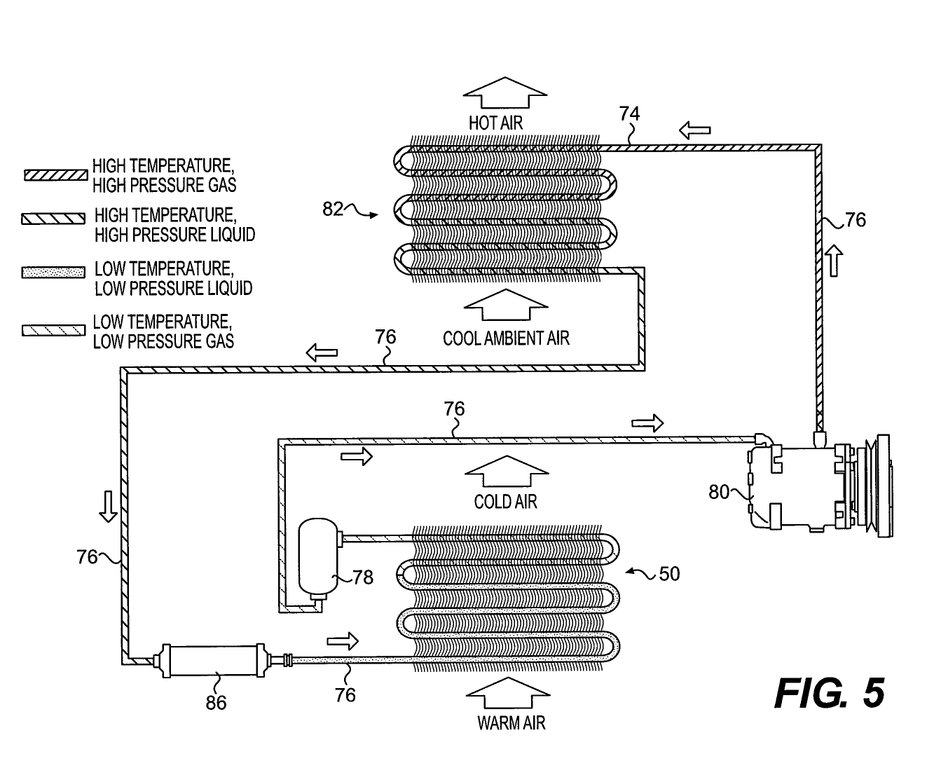

As shown in FIGS. 4 and 5, exemplary system 46 includes an operator interface 72 coupled to system 46 for providing an operator with control of system 46. Operator interface 72 may include controls known to those skilled in the art for controlling the temperature in interior 42 of cab 16.

System 46 also includes a fluid circuit 74 for providing cooling to interior 42 of cab 16. In the exemplary embodiment shown in FIGS. 4 and 5, fluid circuit 74 includes conduit 76 providing flow communication between the various components of system 46, such that a refrigerant in fluid circuit 74 provides cooling for system 46. In particular, evaporator 50 is fluidly coupled via conduit 76 to an accumulator 78, which is configured to collect liquid refrigerant. Although the exemplary system 46 shown in FIGS. 4 and 5 includes accumulator 78, it is contemplated that the function of accumulator 78 may be performed using other similar devices. In the example shown, accumulator 78 is in flow communication with a compressor 80 via conduit 76, and compressor 80 is configured to compress the refrigerant in fluid circuit 74. Compressor 80 is in flow communication with a condenser 82 via conduit 76. Condenser 82 is configured condense refrigerant in fluid circuit 74 and transfer heat from the refrigerant to the exterior air. Condenser 82 may include condenser coils to facilitate heat transfer. One or more fans 84 may be associated with condenser 82 and may blow air across condenser 82 to aid heat transfer. Condenser 82 is in flow communication with evaporator 50 via conduit 76. Evaporator 50 is configured to cool the refrigerant in fluid circuit 74. As shown in FIG. 5, fluid circuit 74 may include a dryer 86 associated with fluid circuit 74 prior to evaporator 50.

During operation of exemplary system 46 to cool interior 42 of cab 16, blower fan 48 blows air drawn from first inlet 56 and/or second inlet 60 through duct 52 and across or through evaporator 50 in chamber 64. As explained below, evaporator 50 is cold and as air blows across or through evaporator 50, the air is cooled. Once cooled, the air continues into ventilation passages 68 and exits vents 70 into interior 42 of cab 16, thereby cooling interior 42. According to some embodiments, to heat interior 42 of cab 16, blower fan 48 blows air drawn from first inlet 56 and/or second inlet 60 through duct 52 and across or through heater core 51 in chamber 64. When system 46 is used for heating, heater core 51 is hot and as air blows across or through heater core 51, the air is heated. Once heated, the air continues into ventilation passages 68 and exits vents 70 into interior 42 of cab 16, thereby heating interior 42.

Exemplary evaporator 50 is cooled by fluid circuit 74. In particular, refrigerant in the form of a relatively low temperature, low pressure gas flows via conduit 76 to accumulator 78, where it is accumulated prior to flowing to compressor 80 via conduit 76. In compressor 80, the refrigerant is compressed, resulting in the refrigerant converting to a relatively high temperature, high pressure gas. The refrigerant thereafter flows via conduit 76 to condenser 82, where the refrigerant gas is condensed into a relatively high temperature, high pressure liquid. Thereafter, the refrigerant flows via conduit 76 to evaporator 50, where the liquid refrigerant is cooled via evaporation. Evaporator 50 may include an expansion valve (not shown) to facilitate evaporation of the liquid refrigerant. As air blows across or through evaporator 50, which has been cooled by virtue of evaporation of the refrigerant, the air is cooled.

### INDUSTRIAL APPLICABILITY

Exemplary machine 10 includes a system 46 for controlling the temperature of interior 42 of cab 16. As shown in FIG. 2, exemplary system 46 includes a blower fan 48 coupled to rear end 32 of cab 16, and an evaporator 50 (e.g., an evaporator coil) coupled to underside 34 of cab 16. A duct 52 coupled to blower fan 48 extends between blower fan 48 and evaporator 50. According to some embodiments, the cross-sectional area of duct 52 expands (e.g., gradually) as it extends from blower fan 48 to evaporator 50.

The exemplary system 46 may result in improved use of limited space associated with cab 16. By virtue of blower fan 48 being separated from evaporator 50, two relatively more compact spaces may be used to receive blower fan 48 and evaporator 50. In addition, compared with HVAC systems not mounted on a cab, by virtue of blower fan 48 and evaporator 50 being mounted on cab 16, movement of cab 16 (e.g., pivoting for access to machine components under cab 16) does not lead to problems that may be associated with movement of cab 16. For example, if blower fan 48 and evaporator 50 are mounted on chassis 12, movement of cab 16 may result in degradation of any sealing of ductwork associated with the HVAC system. Further, by virtue of exemplary duct 52 gradually increasing in cross-sectional area as it extends from blower fan 48 to evaporator 50, system 46 may provide improved flow to ventilation passages 68 and improved temperature control performance for interior 42 of cab 16. This exemplary arrangement may also result in quieter flow of air through duct 52 and ventilation passages 68.

It will be apparent to those skilled in the art that various modifications and variations can be made to the exemplary disclosed systems and methods. Other embodiments will be apparent to those skilled in the art from consideration of the specification and practice of the exemplary disclosed embodiments. It is intended that the specification and examples be considered as exemplary only, with a true scope being indicated by the following claims and their equivalents.

What is claimed is:

1. A system for controlling temperature inside a machine cab defining an interior and an exterior, the system comprising:
a blower fan configured to be coupled to the exterior of the cab;
an evaporator configured to be coupled to the exterior of the cab at a location separated from the blower fan; and
a duct configured to be coupled to the blower fan and the evaporator such that the duct extends between the blower fan and the evaporator.

2. The system of claim 1, wherein the cab defines a rear end and an underside, and wherein the blower fan is configured to be coupled to the rear end of the cab, and the evaporator is configured to be coupled to the underside of the cab.

3. The system of claim 1, wherein the duct has an increasing cross-sectional area as it extends from the blower fan to the evaporator.

4. The system of claim 1, wherein the evaporator includes an evaporator coil.

5. The system of claim 1, further including a plenum including a first inlet configured to receive air from the interior of the cab and a second inlet configured to receive air from the exterior of the cab.

6. The system of claim 5, further including a first filter associated with the first inlet and a second filter associated with the second inlet.

7. The system of claim 1, further including a chamber configured to receive the evaporator, wherein the duct is configured to be coupled to the chamber and provide flow communication between the blower fan and the evaporator.

8. The system of claim 7, further including a ventilation passage configured to extend into the interior of the cab, wherein the ventilation passage is configured to be coupled to the chamber, such that flow communication is provided between the blower fan, the duct, the evaporator, and the ventilation passage.

9. A machine comprising:
a chassis;
ground engaging members coupled to the chassis;
a cab defining an interior and an exterior, the cab being coupled to the chassis; and
a system for controlling temperature in the interior of the cab, the system including:
a blower fan coupled to the exterior of the cab;
an evaporator coupled to the exterior of the cab at a location separated from the blower fan; and
a duct coupled the blower fan and the evaporator and extending between the blower fan and the evaporator.

10. The machine of claim 9, wherein the system for controlling temperature further includes an accumulator, a compressor, and a condenser, and wherein the compressor and the condenser are coupled to the chassis.

11. The machine of claim 9, wherein the cab is coupled to the chassis such that the cab is able to pivot with respect to the chassis.

12. The machine of claim 9, wherein the cab defines a rear end and an underside, and wherein the blower fan is coupled to the rear end of the cab, and the evaporator is coupled to the underside of the cab.

13. The machine of claim 9, wherein the duct has an increasing cross-sectional area as it extends from the blower fan to the evaporator.

14. The machine of claim 9, wherein the evaporator includes an evaporator coil.

15. The machine of claim 9, further including a plenum including a first inlet for receiving air from the interior of the cab and a second inlet for receiving air from the exterior of the cab.

16. The machine of claim 15, further including a first filter associated with the first inlet and a second filter associated with the second inlet.

17. The machine of claim 9, further including a chamber receiving the evaporator, wherein the duct is coupled to the chamber and provides flow communication between the blower fan and the evaporator.

18. The machine of claim 17, further including a ventilation passage extending into the interior of the cab, wherein the ventilation passage is coupled to the chamber, and flow communication is provided between the blower fan, the duct, the evaporator, and the ventilation passage.

19. A system for controlling temperature inside a machine cab defining an interior, the system comprising:
a blower fan configured to be coupled to a cab;
an evaporator configured to be coupled to the cab at a location separated from the blower fan; and
a duct coupled to the blower fan and the evaporator and extending between the blower fan and the evaporator,
wherein the duct has an increasing cross-sectional area as it extends from the blower fan to the evaporator.

20. The system of claim 19, wherein the cab defines a rear end and an underside, and wherein the blower fan is configured to be coupled to the rear end of the cab, and the evaporator is configured to be coupled to the underside of the cab.
